(19) United States
(12) Patent Application Publication
(10) Pub. No.: US 2018/0376058 A1
(43) Pub. Date: Dec. 27, 2018

(54) DISPLAY PROCESSING APPARATUS, DISPLAY PROCESSING METHOD, AND COMPUTER-READABLE MEDIUM FOR EXECUTING DISPLAY PROCESSING METHOD

(71) Applicant: CANON KABUSHIKI KAISHA, Tokyo (JP)

(72) Inventor: Kazunari Iwamoto, Kawasaki-shi (JP)

(21) Appl. No.: 15/780,571

(22) PCT Filed: Nov. 25, 2016
(86) PCT No.: PCT/JP2016/004956

§ 371 Date: May 31, 2018

(30) Foreign Application Priority Data
Dec. 2, 2015 (JP) 2015-236065
Dec. 2, 2015 (JP) 2015-236066

(51) Int. Cl. H04N 5/232; H04N 5/262; H04N 7/18; H04N 5/225

(52) U.S. Cl. CPC H04N 5/23238; H04N 5/2259; H04N 7/181; H04N 5/2628

(57) ABSTRACT

An image reproducing apparatus includes a display processing unit configured to process display of a timeline indicating a time period during which an image captured by a camera capable of changing an imaging direction is recorded. The display of the time period on the timeline is processed depending on the imaging direction.

### TECHNICAL FIELD

The present invention relates to an information processing apparatus, an information processing method, and a program, and is particularly suitable for displaying a timeline used to reproduce a captured image of a monitoring camera. There is a technique for displaying, as a panoramic image, a range in which an imaging apparatus can capture an image. Patent Literature (PTL) 1 discusses a technique for displaying, on a timeline, a time period during which a recorded video image of a target imaging apparatus exists and a time period during which a recorded video image of other imaging apparatus exists.

### BACKGROUND ART

There is a technique for presenting to a user time periods during which recorded video images of an imaging apparatus exist by displaying on a timeline time periods during which recorded video images of an imaging apparatus are stored.

For example, PTL 2 discusses a technique for displaying a user-specified area on the screen of a portable terminal and performing zoom control so that an image in this area is enlarged over the entire screen.

### CITATION LIST

### Patent Literature

PTL 1: Japanese Patent Application Laid-Open No. 2013-17173
PTL 2: Japanese Patent Application Laid-Open No. 2004-157869

### SUMMARY OF INVENTION

### Technical Problem

The technique discussed in PTL 1 does not discuss a mechanism with which a user intuitively grasps time, on a timeline, when a recorded video image in a desired imaging direction exists.

### Solution to Problem

The present invention has been devised to solve the above-described problem, and is directed to a technique for enabling a user to determine the imaging direction of an image generated by being captured by an imaging apparatus.

According to an aspect of the present invention, an image reproducing apparatus includes, a display processing unit configured to process display of a timeline indicating a time period during which an image captured by a camera capable of changing an imaging direction is recorded, the display of the time period on the timeline being processed depending on the imaging direction, and an image reproducing unit configured to reproduce an image corresponding to a time specified on the timeline.

Further features of the present invention will become apparent from the following description of exemplary embodiments with reference to the attached drawings.

### BRIEF DESCRIPTION OF DRAWINGS

FIG. 1 illustrates a configuration of a display system.

FIG. 2 illustrates a configuration of an imaging apparatus.

FIG. 3 illustrates a configuration of a client apparatus.

FIG. 4 is a flowchart illustrating a first example of processing of the client apparatus.

FIG. 5 illustrates relations between imaging directions of the imaging apparatus and display patterns.

FIG. 6 illustrates a situation where the imaging apparatus is installed.

FIG. 7 illustrates a panoramic image.

FIG. 8 illustrates a panoramic image in which imaging directions of the imaging apparatus are superimposed.

FIG. 9 is a flowchart illustrating a second example of processing of the client apparatus.

FIG. 10 illustrates a timeline.

FIG. 11 illustrates a timeline on which imaging directions of the imaging apparatus are superimposed.

FIG. 12 is a flowchart illustrating a first example of processing of the client apparatus.

FIG. 13 illustrates relations between coordinate ranges on a panoramic image and display patterns.

FIG. 14 illustrates a panoramic image on which display patterns are superimposed.

FIG. 15 illustrates a timeline which indicates recording time periods of video images in specified ranges.

FIG. 16 is a flowchart illustrating the second example of processing of the client apparatus.

### DESCRIPTION OF EMBODIMENTS

Exemplary embodiments will be described in detail below with reference to the accompanying drawings. A first exemplary embodiment will be described below centering on an example of a method for displaying imaging directions of an imaging apparatus on a panoramic image. A second exemplary embodiment will be described below centering on an example of a method for displaying imaging directions of the imaging apparatus on a timeline of recorded video images of the imaging apparatus.

### First Exemplary Embodiment

The first exemplary embodiment will be described below. As described above, the present exemplary embodiment will be described below centering on an example of a method for displaying an imaging direction of the imaging apparatus on a panoramic image.

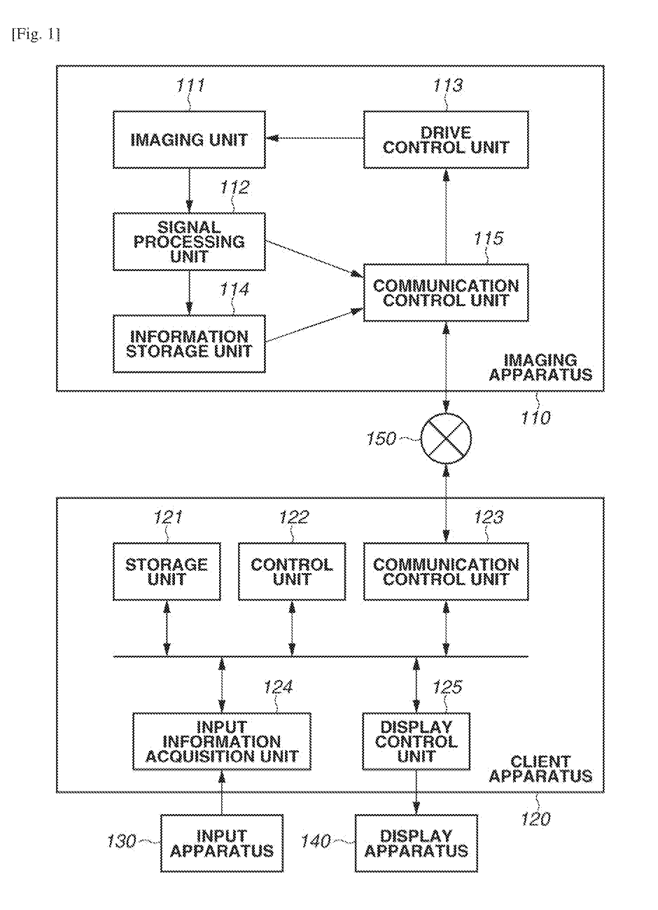

FIG. 1 is a block diagram illustrating an example of a configuration of a display system according to the present exemplary embodiment.

Referring to FIG. 1, the display system includes an imaging apparatus 110, a client apparatus 120, an input apparatus 130, and a display apparatus 140. The imaging apparatus 110 and the client apparatus 120 are connected via a network 150 so that they can communicate with each other.

The imaging apparatus 110 captures an image of an object. The imaging apparatus 110 has a function of changing the imaging direction and imaging view angle. The client apparatus 120 acquires information about the imaging direction and imaging view angle of the imaging apparatus 110, and a panoramic image. The input apparatus 130 includes a mouse, a keyboard, etc., and receives an operation, issued to the client apparatus 120, input by a user. The display apparatus 140 displays an image the client apparatus 120 outputs. FIG. 1 illustrates the client apparatus 120 and the display apparatus 140 as independent apparatuses. However, the client apparatus 120 and the display apparatus 140 may be integrally formed. The network 150 allows interconnection between the imaging apparatus 110 and the client apparatus 120. The network 150 includes a plurality of routers, which satisfies a communication standard such as Ethernet (registered trademark), switches, and cables. The communication standard, scale, and configuration of the network 150 do not matter as long as the imaging apparatus 110 and the client apparatus 120 can communicate with each other. For example, the network 150 may be configured with the Internet, a wired local area network (LAN), a wireless LAN, or a wide area network (WAN).

An example of a functional configuration of the imaging apparatus 110 will be described below.

An imaging unit 111 includes an image sensor and an optical system for forming an object image on the image sensor. The imaging unit 111 captures an image on a solid-state image sensor by setting the intersection of the optical axis of the optical system and the image sensor as an imaging center. The solid-state image sensor is such an image sensor as a complementary metal-oxide semiconductor (CMOS) sensor or a charge coupled device (CCD) sensor.

The signal processing unit 112 performs processing on an image signal captured by the imaging unit 111. The signal processing unit 112 performs encoding, for example, on the image signal obtained by the imaging unit 111. As a coding method, for example, Joint Photographic Experts Group (JPEG) can be used. For example, H.264/MPEG-4 AVC can also be used as a coding method. In addition, High Efficiency Video Coding (HEVC) can also be used as a coding method. However, the coding method is not limited thereto. The signal processing unit 112 may select a coding method from a plurality of coding methods and performs encoding. The signal processing unit 112 also performs, for example, the following image processing. More specifically, the signal processing unit 112 also performs processing including processing for concatenating processed image signals to generate a panoramic image and filter processing on the processed image signals.

The drive control unit 113 performs control for changing the imaging direction and imaging view angle of the imaging unit 111. The present exemplary embodiment will be described below centering on a case where the imaging unit 111 is capable of changing the imaging direction in the pan and tilt directions and changing the imaging view angle.

An information storage unit 114 stores, for example, the above-described panoramic image as an image signal (captured image) processed by the signal processing unit 112, together with such information as the imaging direction during imaging, the imaging view angle during imaging, the imaging time, etc., as a recorded video image.

According to the present exemplary embodiment, the imaging apparatus 110 is assumed to be installed on the ceiling. The imaging apparatus 110 (imaging unit 111) has a driving range in the pan direction of −180 to 179 degrees and a driving range in the tilt direction of 0 to 90 degrees. In a case where the tilt value (angle) of the imaging apparatus 110 is 90 degrees, the imaging apparatus 110 (imaging unit 111) is directed to the direction perpendicular to the floor of the space where the imaging apparatus 110 is installed (more specifically, the imaging apparatus 110 is directed just downward).

A communication control unit 115 transmits the image signal (captured image) processed by the signal processing unit 112 to the client apparatus 120. For the captured image to be transmitted, for example, information about the imaging time, the imaging direction (pan and tile angles), and the imaging view angle is recorded in the header of each captured image frame. The communication control unit 115 further receives a control instruction from the client apparatus 120 to the imaging apparatus 110. The communication control unit 115 further receives an instruction from the client apparatus 120, extracts information of each frame of a recorded video image (panoramic image) stored in the information storage unit 114, and transmits the information to the client apparatus 120.

An example of a functional configuration of the client apparatus 120 will be described below.

The storage unit 121 in the client apparatus 120 stores the contents of programs and various data to be used for processing in programs. A control unit 122 performs processing of flowcharts (described below) by reading and executing a program stored in the storage unit 121. An input acquisition unit 124 inputs the contents of an input operation performed on the input apparatus 130 by the user. A display control unit 125 outputs a video image to the display apparatus 140 according to the result of program processing performed by the control unit 122.

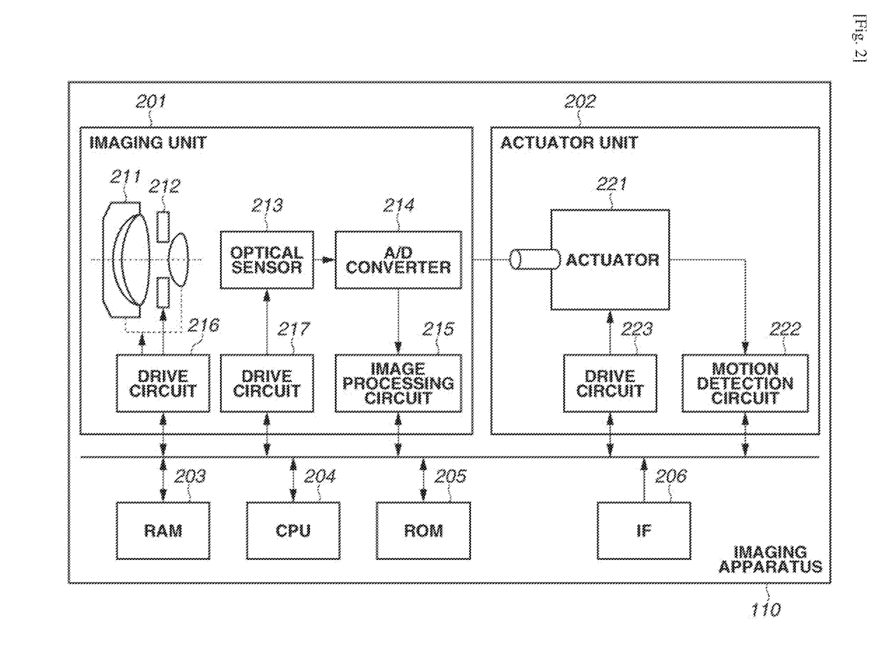

FIG. 2 illustrates an example of a hardware configuration of the imaging apparatus 110.

The imaging apparatus 110 includes an imaging unit 201, an actuator unit 202, a random access memory (RAM) 203, a central processing unit (CPU) 204, a read only memory (ROM) 205, and an interface (IF) 206.

Referring to FIG. 2, the light from an object passes through a photographic lens unit 211 including an optical system, and a diaphragm unit 212 to form an object image on the optical sensor 213. The photographic lens unit 211 moves a lens group, for example, by using a motor to focus on the object. The diaphragm unit 212 has a mechanism capable of controlling a diaphragm. A drive circuit 216 controls operations of the photographic lens unit 211 and the diaphragm unit 212.

Accordingly, the drive circuit 216 controls the photographic lens unit 211 and the diaphragm unit 212 so as to adjust the light quantity that reaches the optical sensor 213 (to be imaged thereon). The optical sensor 213, configured with the above-described solid-state image sensor, converts incident light into electric charges according to the light quantity and accumulates the electric charges. The optical sensor 213 reads the accumulated electric charges and outputs them to an analog-to-digital (A/D) converter 214 as an image signal.

The operation of the optical sensor 213 is controlled by a pulse signal output by a drive circuit 217. More specifically, the optical sensor 213 continuously performs a series of operations for reading electric charges accumulated during the specified time period, at a timing specified by the drive circuit 217. Thus, a continuous image (moving image) is obtained. The imaging apparatus 110 according to the present exemplary embodiment is also capable of capturing a still image.

The A/D converter 214 performs A/D conversion on the image signal received from the optical sensor 213 and outputs the resultant digital data (image data) to an image processing circuit 215. The image processing circuit 215 performs image correction such as white balance correction and gamma correction on the image data received from the A/D converter 214. The image processing circuit 215 further performs encoding on the image data having undergone the image correction. An example of a coding method is as described above. The image processing circuit 215 also generates the above-described panoramic image and performs filter processing on the panoramic image.

A CPU 204 controls the entire imaging apparatus 110. For example, the CPU 204 controls the overall operation of the imaging apparatus 110 by executing, via the RAM 203, a program stored in the ROM 205. The CPU 204 performs, for example, information calculation and processing and controls each hardware component. The RAM 203 functions as a main memory of the CPU 204 and as a work memory required to load and execute a program. The ROM 205 stores a program that specifies operation processing procedures of the CPU 204. The ROM 205 includes a program ROM for storing an operating system (OS) which is a system program for controlling devices of a computer system and a data ROM for storing information required for system operation.

The interface (IF) 206 includes a user interface and a communication interface. The user interface includes, for example, buttons and dials and receives a user-input operation to the imaging apparatus 110. The communication interface performs input/output control of data to be transmitted and received to/from an external apparatus such as the client apparatus 120 connected to the network 150.

When a request for moving or rotating the imaging unit 201 is input from an apparatus on the network 150 or the interface 206 (user interface) to the imaging apparatus 110, the CPU 204 instructs a drive circuit 223 to perform the instructed movement and or rotation. The drive circuit 223 controls the actuator 221 based on this instruction. According to the control by the drive circuit 223, the actuator 221 rotates and or moves the imaging unit 201 by using a servo motor or an ultrasonic motor. A motion detector circuit 222 detects the amount of motions (amount of movement and amount of rotation) of the actuator 221 and records the detected amount of motions in the RAM 203 at each predetermined timing.

For example, the hardware of the imaging apparatus 110 can be implemented, for example, by using known camera hardware which performs operations in the pan and tilt directions, and is not limited to the one illustrated in FIG. 2.

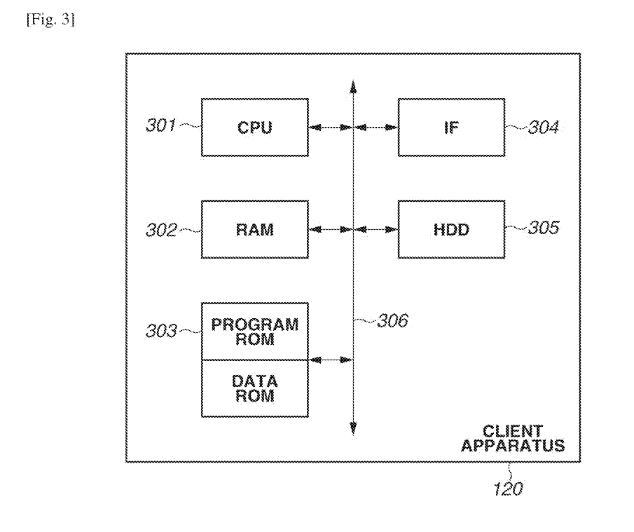

FIG. 3 illustrates an example of a hardware configuration of the client apparatus 120.

The CPU 301 controls the entire client apparatus 120. For example, the CPU 301 controls overall operations of the client apparatus 120 by executing, via a RAM 302, a program stored in a ROM 303 or a hard disk drive (HDD) 305. The CPU 301 performs, for example, information calculation and processing and controls each hardware component. The RAM 302 functions as a main memory of the CPU 301 and as a work memory required to load and execute a program.

The ROM 303 stores a program that specifies operations and processing procedures of the CPU 301. The ROM 303 includes a program ROM for storing an operating system (OS) which is a system program for controlling devices of a computer system and a data ROM for storing information required for system operation. The HDD 305 (described below) may be used instead of the ROM 303.

An interface 304 includes a communication interface, an input interface, and a display interface. The communication interface performs input/output control of data transmitted and received to/from an external apparatus such as the imaging apparatus 110 connected to the network 150. The input interface is an interface between the input apparatus 130 and the client apparatus 120. A display interface is an interface between the display apparatus 140 and the client apparatus 120.

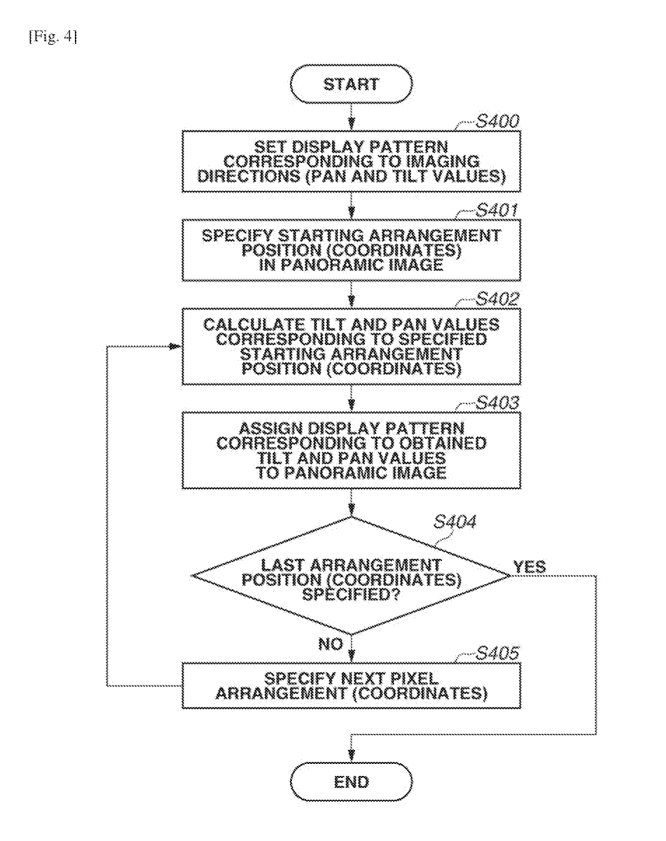

The HDD 305 stores data of an application program which performs processing of the flowcharts illustrated in FIGS. 4 and 9. An input/output bus 306 is used to connect between the above-described units. The input/output bus 306 includes, for example, an address bus, a data bus, and a control bus.

The hardware of the client apparatus 120 can be implemented, for example, by using a hardware device of a known information processing apparatus such as a personal computer, and is not limited to the one illustrated in FIG. 3.

An example of processing by the client apparatus 120 will be described below with reference to the flowchart illustrated in FIG. 4. A description is given of an example of a method in which the client apparatus 120 displays, in each area of the panoramic image generated by the imaging apparatus 110, an imaging direction of the imaging apparatus 110 used when the area has been captured as a display pattern. The processing of the flowchart illustrated in FIG. 4 is implemented, for example, when the CPU 301 executes, via the RAM 302, a program stored in the ROM 303 or HDD 305.

According to the present exemplary embodiment, the control unit 122 sets a display pattern corresponding to the imaging directions (pan and tilt values) of the imaging apparatus 110 as preprocessing of step S400. Then, as processing in steps S401 to S405, the control unit 122 performs processing for displaying the display pattern indicating the above-described imaging directions on the panoramic image. An example of each piece of processing will be described in detail below.

In step S400, the control unit 122 sets the display pattern corresponding to the imaging directions (pan and tilt values) of the imaging apparatus 110. According to the present exemplary embodiment, the control unit 122 divides the driving range of the imaging apparatus 110 into the following five ranges (1) to (5) and automatically sets a display pattern corresponding to the respective five driving ranges.

(1) [−180 degrees≤panning angle (value)<90 degrees] and [0 degrees≤tilting angle (value)<45 degrees]
(2) [−90 degrees≤panning angle<0 degrees] and [0 degrees≤tilting angle<45 degrees]
(3) [0 degrees≤panning angle<90 degrees] and [0 degrees≤tilting angle<45 degrees]
(4) [90 degrees≤panning angle≤179 degrees] and [0 degrees≤tilting angle<45 degrees]
(5) [−180 degrees≤panning angle≤179 degrees] and [45 degrees≤tilting angle≤90 degrees]

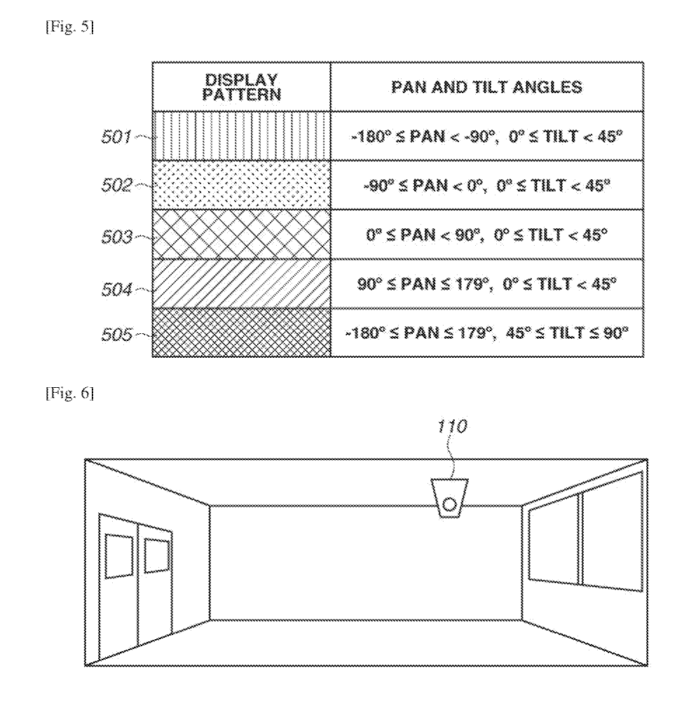

FIG. 5 illustrates examples of relations between the imaging directions (pan and tilt values) of the imaging apparatus 110 and display patterns in tabular form. The relations illustrated in FIG. 5 are stored in the HDD 305 through the processing in step S400.

Display patterns 501 to 505 illustrated in FIG. 5 indicate display patterns associated with the above-described driving ranges (1) to (5), respectively.

The present exemplary embodiment will be described below centering on an example of a case where a display pattern to be displayed in the panoramic image includes points or lines. However, a pattern to be displayed in the panoramic image is not limited thereto. A display pattern may be a graphic pattern, a color, a character string which characterizes the imaging direction of the imaging apparatus 110, or a combination of any two of them.

The present exemplary embodiment will be described below centering on an example of a case where the driving range of the imaging apparatus 110 is divided based on the result of image processing on the image captured by the imaging apparatus 110 and a display pattern is automatically associated with each division driving range. However, the association of the display pattern with the driving range of the imaging apparatus 110 is not limited thereto. For example, at least any one of the display pattern type corresponding to respective driving ranges of the imaging apparatus 110 and the driving ranges of the imaging apparatus 110 after division may be determined based on a user input operation via the input apparatus 130. Further, it is also possible to generate in advance and use a panoramic image in which the imaging directions and coordinates of a captured image (described below) are associated with each other. For example, it is also possible to segmentalize a panoramic image by applying an area segmentation algorithm such as graph cut and watershed, calculate the imaging directions of the imaging apparatus 110 based on the segmentalized areas, and associate the driving ranges of the imaging apparatus 110 with respective areas.

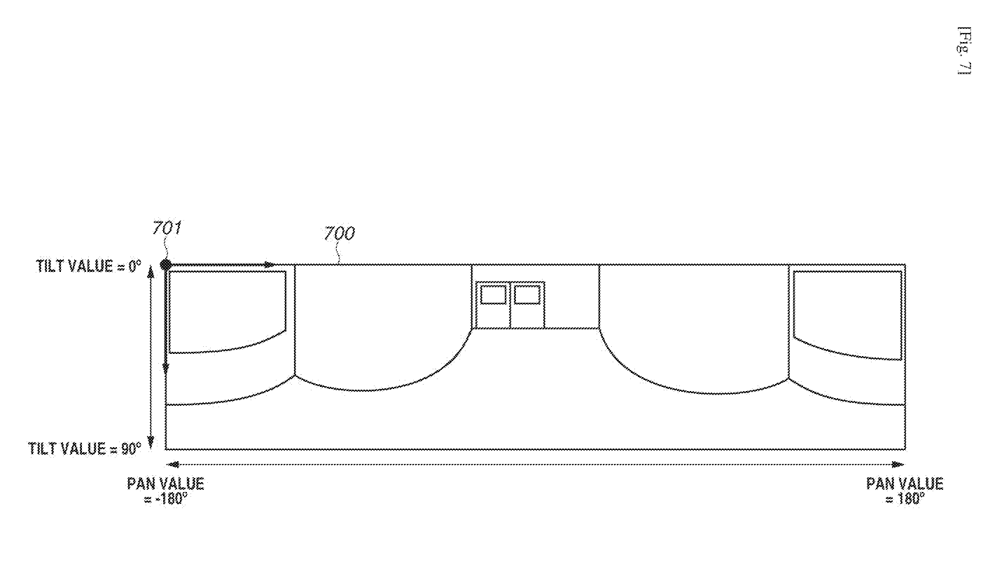

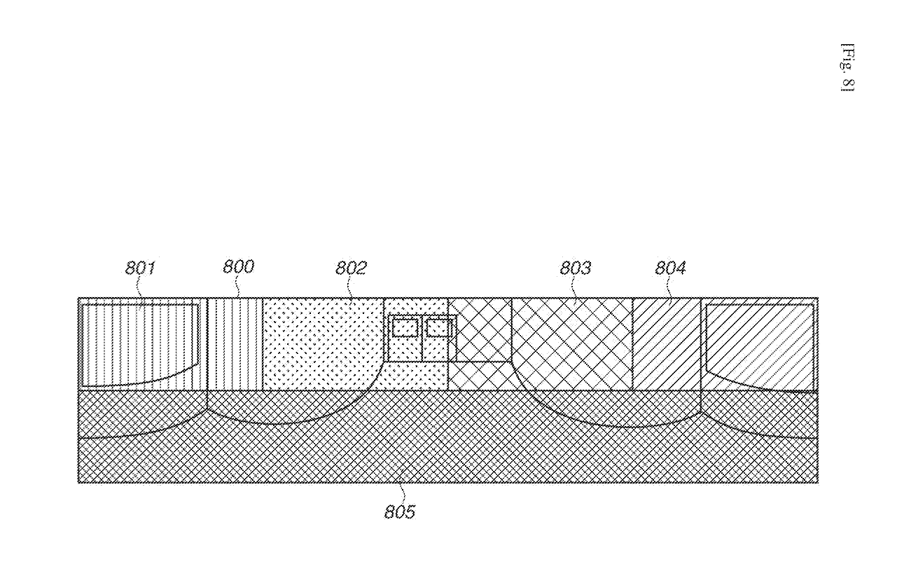

In steps S401 to S405, the control unit 122 performs processing for displaying a display pattern on a panoramic image. FIG. 6 illustrates an example of a situation, seen from the lateral side, where the imaging apparatus 110 is installed in a room where windows and doors exist. FIG. 7 illustrates an example of a panoramic image 700 generated by driving the imaging apparatus 110 in the pan and tilt directions in the environment illustrated in FIG. 6. In the panoramic image 700 illustrated in FIG. 7, the horizontal axis corresponds to the driving range in the pan direction, and the vertical axis corresponds to the driving range in the tilt direction. A two-dimensional coordinate system is defined in which an upper left corner 601 of the panoramic image 700 is the origin of coordinates, the horizontal axis is the x axis, and the vertical axis is the y axis. Coordinates of a certain point on the panoramic image 700 are represented by two-dimensional coordinates (x, y).

A description is given of an example of a flow of processing for scanning a panoramic image and displaying a pattern on the panoramic image.

### <Processing 1>

In step S401, the control unit 122 assigns each pixel on the panoramic image to the two-dimensional coordinates and specifies the starting position of pixel arrangements. The present exemplary embodiment will be described below centering on an example of a case where the client apparatus 120 receives a panoramic image stored in the information storage unit 114 and performs processing on the panoramic image. However, it is not always necessary to perform processing in this way. For example, before performing the processing in step S401 (processing 1), the client apparatus 120 may acquire image data captured by the imaging apparatus 110 while changing the pan and tilt values and generate a panoramic image inside the client apparatus 120.

<Processing 2>

In step S402, the control unit 122 acquires the pan and tilt values of the imaging apparatus 110 corresponding to the current pixel arrangement position (coordinates) specified for the panoramic image 700. In the present exemplary embodiment, a panoramic image in which the horizontal axis corresponds to panning and the vertical axis corresponds to tilting is used, as illustrated in FIG. 7. Accordingly, by applying the following formula (1) to certain coordinates (x, y) on the panoramic image 700, the pan and tilt values of the imaging apparatus 110 corresponding to coordinates (x, y) is able to be calculated.

$$[ Math . 1 ]$$

$$( \begin{matrix}Pan \\ Tilt\end{matrix} ) = ( \begin{matrix}\frac{x}{W} ( P max - P min ) + P min \\ \frac{y}{H} ( T max - T min )\end{matrix} ) \qquad ( 1 )$$

Referring to formula (1), W and H denote the width and height of the panoramic image 700, respectively. Pmax and Pmin indicate the maximum and the minimum values of the driving range of the imaging apparatus 110 in the pan direction, respectively. Tmax and Tmin indicate the maximum and the minimum values of the driving range of the imaging apparatus 110 in the tilt direction. The present exemplary embodiment will be described below centering on an example of a case where the pan and tilt values of the imaging apparatus 110 are calculated based on the width, height, and coordinates of the panoramic image. However, the method for deriving the pan and tilt values of the imaging apparatus 110 is not limited thereto. An example of this method will be described below. First of all, when a panoramic image is generated, a table for storing the coordinates of the panoramic image and the pan and tilt values of the imaging apparatus 110 is created in association with each other. This table may be generated either by the imaging apparatus 110 or by the client apparatus 120. In step S402, the control unit 122 derives the pan and tilt values of the imaging apparatus 110 (the imaging direction of the imaging apparatus 110) by referring to the table.

<Processing 3>

The control unit 122 refers to the display pattern corresponding to the imaging direction (pan and tilt values) of the imaging apparatus 110 set in step S400 and determines the display pattern corresponding to the pan and tilt values of the imaging apparatus 110 derived in step S402 (processing 2). In step S403, the control unit 122 assigns the determined display pattern to the current pixel arrangement position (coordinates) specified for the panoramic image 700.

<Processing 4>

In step S404, the control unit 122 determines whether the current arrangement position (coordinates) specified for the panoramic image 500 is the last arrangement position (coordinates). In a case where it is determined that the current pixel arrangement position (coordinates) specified for the panoramic image 500 is the last pixel arrangement position (coordinates) (YES in step S404), the processing exits the flowchart illustrated in FIG. 4.

On the other hand, when the current pixel arrangement position (coordinates) specified for the panoramic image 500 is not the last pixel arrangement position (coordinates) (NO in step S404), then in step S405, the control unit 122 specifies the next pixel arrangement position (coordinates). Then, the control unit 122 performs the above-described processing in steps S402 and S403 on the specified pixel arrangement position (coordinates). In this way, the control unit 122 repeatedly performs the processing in steps S402 to S405 until a display pattern is assigned to all of the pixel arrangement positions (coordinates) for the panoramic image 500.

In the present exemplary embodiment, after completion of the above-described processing illustrated in FIG. 4, the display control unit 125 displays the panoramic image (panoramic image in which display patterns are superimposed) on the display apparatus 140. This configuration enables a panoramic image in which the display patterns indicating the imaging directions of the imaging apparatus 110 are displayed to be exhibited for the user.

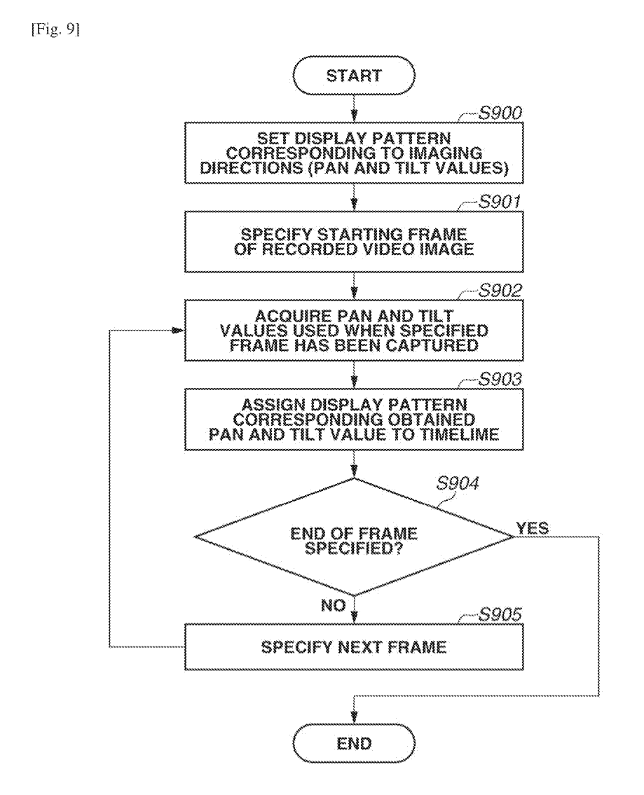

As described above, in the present exemplary embodiment, the control unit 122 stores the range of the imaging directions of the imaging apparatus 110 and display patterns in association with each other. The control unit 122 identifies the imaging directions of the imaging apparatus 110 used when each area (coordinates) of the panoramic image has been captured. Then, the control unit 122 displays display patterns 801 to 805 corresponding to the identified imaging directions of the imaging apparatus 110 on the panoramic image in a superimposed way so that at least a part of areas of the original panoramic image becomes visually recognizable. FIG. 8 illustrates an example of a panoramic image 800 in which display patterns 801 to 805 indicating the imaging directions of the imaging apparatus 110 are displayed. As illustrated in FIG. 8, the display patterns 801 to 805 are semi-transparent and displayed on the panoramic image 800 in a superimposed way so that at least a part of areas of the original panoramic image 800 becomes visually recognizable.

The display patterns 801 to 805 illustrated in FIG. 8 indicate the display patterns respectively corresponding to the driving ranges (1) to (5) of the imaging apparatus 110. Presenting such a screen for displaying the panoramic image 800 to the user allows the user to determine that, for example, the doors in the room exist within the driving range (2) of the imaging apparatus 110. The table illustrated in FIG. 5 may be displayed in the display screen together with the panoramic image 800 with the display patterns illustrated in FIG. 8.

The present exemplary embodiment has been specifically described above centering on an example of a case where display patterns indicating the imaging directions of the imaging apparatus 110 are displayed in a panoramic image in which the horizontal axis corresponds to the driving range in the pan direction and the vertical axis corresponds to the driving range in the tilt direction. However, the panoramic image is not limited thereto. For example, the panorama range may be a panoramic image captured by a fish-eye lens or may be a partially clipped panoramic image.

The present exemplary embodiment has been specifically described above centering on a processing method in the imaging apparatus 110 capable of performing pan driving and tilt driving. However, the imaging apparatus 110 is not limited to the one capable of performing pan driving and tilt driving. For example, if the panoramic image is replaced with a captured image and the pan and tilt values are replaced with coordinates on the captured image in the descriptions of the present exemplary embodiment, the present exemplary embodiment is applicable to an imaging apparatus without a function of performing pan driving and tilt driving.

The present exemplary embodiment has been specifically described above centering on an example of a case where a display pattern is superimposed on a panoramic image. However, it is not always necessary to superimpose the display pattern on the panoramic image. For example, when displaying as a display pattern a character string characterizing an imaging direction of the imaging apparatus 110, the following processing is also possible. A display area for the panoramic image and a display area for a display pattern may be separately provided in one screen, and character strings indicating the imaging directions of the imaging apparatus 110 and the coordinate ranges in the imaging directions may be displayed as a display pattern in the display pattern display areas. Instead of this processing, character strings characterizing imaging directions of the imaging apparatus 110 may be displayed on a panoramic image.

### Second Exemplary Embodiment

A second exemplary embodiment will be described below. As described above, the present exemplary embodiment will be described below centering on an example of a method for displaying the imaging direction of an imaging apparatus on the timeline of a recorded video image of the imaging apparatus. The present exemplary embodiment mainly differs from the first exemplary embodiment in the display target in the imaging direction of the imaging apparatus. Accordingly, in the descriptions of the present exemplary embodiment, elements identical to those in the first exemplary embodiment are assigned the same reference numerals as those in FIGS. 1 to 8, and detailed descriptions thereof will be omitted. For example, since drawings (FIGS. 1 to 3) illustrating configurations of the imaging display system, the imaging apparatus 110, and the client apparatus 120 according to the present exemplary embodiment are similar to those according to the first exemplary embodiment, and detailed descriptions thereof will be omitted. According to the present exemplary embodiment, the space and place where the imaging apparatus 110 is installed and the driving ranges in the pan and tilt directions are similar to those according to the first exemplary embodiment.

An example of processing of the client apparatus 120 will be described below with reference to the flowchart illustrated in FIG. 9. A description is given of an example of a method in which the client apparatus 120 displays the imaging directions of the imaging apparatus 110 as a display pattern on the timeline of a recorded video image. The processing of the flowchart illustrated in FIG. 9 is implemented, for example, when the CPU 301 executes, via the RAM 302, a program stored in the ROM 303 or HDD 305.

According to the present exemplary embodiment, in step S900, the control unit 122 sets a display pattern corresponding to the imaging directions (pan and tilt values) of the imaging apparatus 110 as preprocessing. In steps S901 to S905, the control unit 122 displays on the timeline of the recorded video image the display pattern indicating the imaging directions of the imaging apparatus 110 according to the first exemplary embodiment. An example of processing according to the present exemplary embodiment will be described in detail below.

In step S900, the control unit 122 sets the display pattern corresponding to the imaging directions (pan and tilt values) of the imaging apparatus 110. The control unit 122 performs processing, for example, processing similar to that in step S400 illustrated in FIG. 4 according to the first exemplary embodiment and stores information about the relation illustrated in FIG. 5 in the HDD 305.

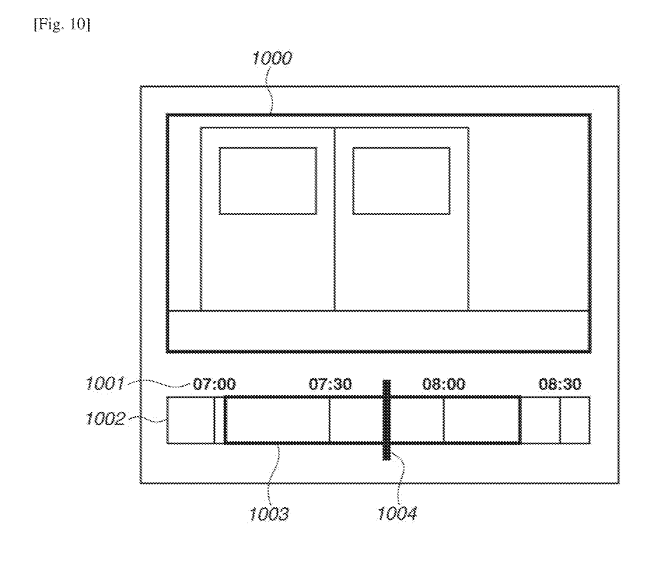

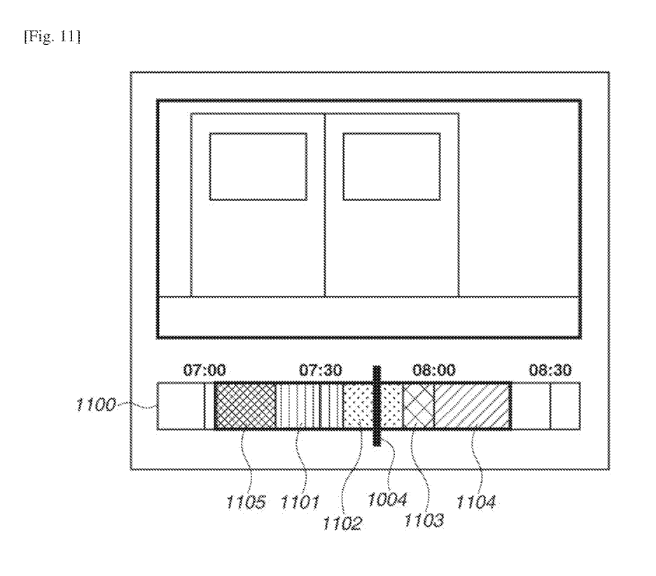

In steps S901 to S905, the control unit 122 displays the display patterns on the timeline. FIG. 10 illustrates an example of a timeline and an example of a user interface for displaying a recorded video image at a time (reproduction position) specified on the timeline. The display control unit 125 performs the following processing under control of the control unit 122. The display control unit 125 displays a recording time display portion 1001 for displaying the recording time above a timeline 1002. The display control unit 125 further displays on the timeline 1002 a recording time period display portion 1003 indicating whether a recorded video image exists, a recording time specification portion 1004 for specifying a recording time of the recorded video image to be displayed on a recorded video image display portion 1000. The display control unit 125 displays on the recorded video image display portion 1000 the recorded video image at a recording time specified by the recording time specification portion 1004.

A description is given of an example of a flow of processing for displaying display patterns on the timeline 1002.

<Processing 1>

In step S901, the control unit 122 specifies the starting frame of a recorded video image. The present exemplary embodiment will be described below centering on an example of a case where the client apparatus 120 receives a recorded video image stored in the information storage unit 114 and performs processing on the recorded video image. However, it is not always necessary to perform processing in this way. For example, before performing the processing in step S901 (processing 1), the client apparatus 120 may acquire image data captured by the imaging apparatus 110 and store the recorded video image inside the client apparatus 120.

<Processing 2>

In step S902, the control unit 122 acquires the pan and tilt values of the imaging apparatus 110 used when the frame specified for the recorded video image has been captured. According to the present exemplary embodiment, the control unit 122 is assumed to acquire the pan and tilt values prestored, in the imaging apparatus 110, as metadata in the header of each frame of the recorded video image. However, the method for acquiring the pan and tilt values of the imaging apparatus 110 is not limited thereto. An example of this method will be described below. In recording a captured image, the control unit 122 generates a table for storing each frame of a recorded video image and the pan and tilt values of the imaging apparatus 110 in association with each other. This table may be generated by the imaging apparatus 110 or by the client apparatus 120. In step S902, the control unit 122 derives the pan and tilt values of the imaging apparatus 110 (the imaging directions of the imaging apparatus 110) by referring to the above-described table.

<Processing 3>

The control unit 122 determines the display pattern corresponding to the pan and tilt values of the imaging apparatus 110 acquired in step S902 (processing 2) by referring to the display patterns corresponding to the imaging directions (pan and tilt values) of the imaging apparatus 110 set in step S900. In step S903, the control unit 122 assigns the determined display pattern in the area on the timeline 1002 indicating the current arrangement (frame) specified for the recorded video image.

<Processing 4>

In step S904, the control unit 122 determines whether the frame currently specified for the recorded video image is the last frame. In a case where the frame currently specified for the recorded video image is the last frame as a result of the determination (YES in step S904), the processing exits the flowchart illustrated in FIG. 9.

On the other hand, in a case where the frame currently specified for the recorded video image is not the last frame (NO in step S904), then in step S905, the control unit 122 specifies the next frame. Then, the control unit 122 performs the above-described processing in steps S902 and S903 on the specified frame. As described above, the control unit 122 repeatedly performs the processing in steps S902 to S905 until the display pattern is assigned to all frames for the recorded video image.

In the present exemplary embodiment, after completion of the above-described processing illustrated in FIG. 10, the display control unit 125 displays a timeline having undergone the processing (timeline on which display patterns are superimposed) on the display apparatus 140. This enables the display apparatus 104 to present to the user the timeline on which the display patterns indicating the imaging directions of the imaging apparatus 110 are displayed.

As described above, in the present exemplary embodiment, the control unit 122 identifies the imaging directions of the imaging apparatus 110 used when each frame of a recorded video image has been captured. Then, the display control unit 125 displays display patterns 1101 to 1105 corresponding to the specified imaging directions of the imaging apparatus 110 on the timeline in a superimposed way so that at least a part of the contents of the original timeline and the recording time specification portion 1004 becomes visually recognizable. FIG. 11 illustrates an example of a timeline 1100 on which the patterns indicating the imaging directions of the imaging apparatus 110 are displayed.

The display patterns 1101 to 1105 illustrated in FIG. 11 indicate the display patterns corresponding to the driving ranges (1) to (5) of the imaging apparatus 110, respectively, according to the first exemplary embodiment. Presenting such a screen for displaying the timeline 1100 to the user allows the user to determine that, for example, a recorded video image captured while the imaging apparatus 110 faces the direction of the driving range (4) exists in the display pattern 1104 displayed on the timeline 1100.

The present exemplary embodiment has specifically been described above centering on an example of a case where a timeline of images (recorded video images) of a plurality of continuous frames is displayed as an example of an object for selecting an image. However, it is not always necessary to display images of a plurality of continuous frames or display the timeline. For example, it is also possible to display a thumbnail image of each of a plurality of images as an example of an object for selecting any one of a plurality of the images. A plurality of images may be images of frames of a moving image or may be still images. In this case, the display control unit 125 displays the above-described display patterns on a plurality of the thumbnail images in a superimposed way according to the imaging directions of the imaging apparatus 110 used when images corresponding to the thumbnail images have been captured. Then, the display control unit 125 displays in an enlarged way an image selected from a plurality of the thumbnail images by the user. In this case, the user may be allowed to select only one of a plurality of the thumbnail images, or select at least two thereof at the same time. The modification according to the first exemplary embodiment can be employed also in the present exemplary embodiment. Additionally, it is useful to display at least one of pan and tilt values corresponding to a position of the time specification portion 1004 near the portion 1004.

### Third Exemplary Embodiment

A third exemplary embodiment will be described below. As described above, the present exemplary embodiment will be described below centering on an example of a method. More specifically, the user specifies an imaging direction of the imaging apparatus by drawing a rectangle on the panoramic image, and the recording time period of the image in the specified imaging direction is displayed on the timeline of the recorded video image.

In the descriptions of the present exemplary embodiment, elements identical to those in the first exemplary embodiment are assigned the same reference numerals as those in FIGS. 1 to 10, and detailed descriptions thereof will be omitted. For example, the configurations of the imaging display system, the imaging apparatus 110, and the client apparatus 120 according to the present exemplary embodiment (FIGS. 1 to 3) are similar to those according to the first exemplary embodiment, and detailed descriptions thereof will be omitted. According to the present exemplary embodiment, the space and place where the imaging apparatus 110 is installed and the driving ranges in the pan and tilt directions are similar to those according to the first exemplary embodiment.

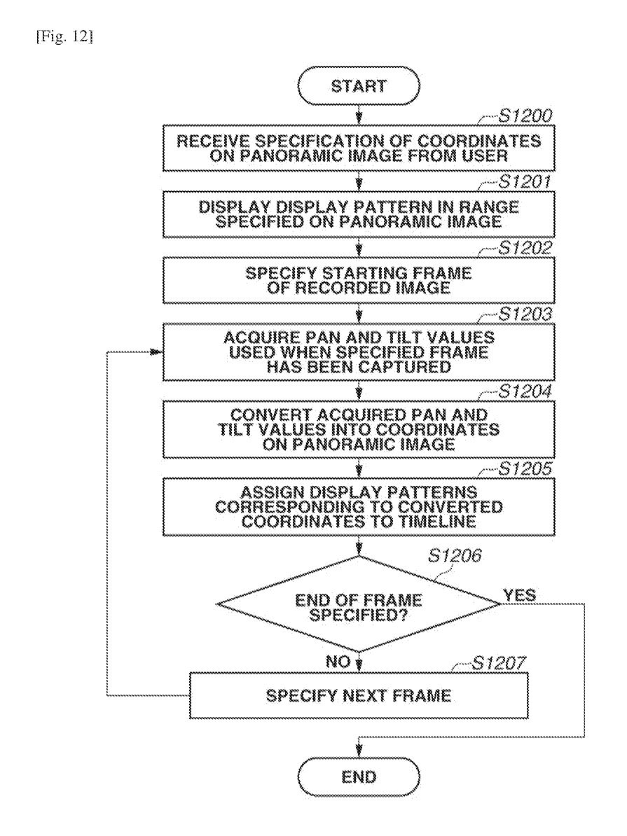

An example of processing of the client apparatus 120 will be described below with reference to the flowchart illustrated in FIG. 12. A description is given of an example of a method in which the client apparatus 120 displays the recording time period of a video image including a coordinate range on a panoramic image specified by the user on the timeline of the recorded video image. The processing of the flowchart illustrated in FIG. 12 is implemented, for example, when the CPU 301 executes, via the RAM 302, a program stored in the ROM 303 or HDD 305.

In step S1200, the input acquisition unit 124 receives coordinates on the panoramic image specified by the user. According to the present exemplary embodiment, the user specifies a desired range on the panoramic image and handles a plurality of coordinates within the specified range as one coordinate set. The coordinate set may include only one coordinates.

According to the present exemplary embodiment, when the user performs a dragging on a panoramic image 600 by operating the input apparatus 130, the input acquisition unit 124 inputs information about the dragged position. The display control unit 125 draws such a rectangle that has the straight line which connects the starting and the ending points of the dragging as a diagonal line and instructs the display apparatus 140 to display the rectangle. The control unit 122 further identifies a coordinate set existing inside the rectangle. The method for identifying a coordinate set on the panoramic image specified by the user is not limited thereto.

For example, the control unit 122 may identify a coordinate set existing inside the locus of a dragging performed on the panoramic image 600 by the user. The user may repeatedly perform a click on the panoramic image 600. In this case, the input acquisition unit 124 inputs the information about the clicked position. The display control unit 125 draws a curve (a spline curve, a Bezier curve, etc.) corresponding to the clicked position and instructs the display apparatus 140 to display the curve. The control unit 122 identifies a coordinate set existing inside the curve. In addition, the display control unit 125 draws various graphic patterns such as rectangles and round shapes on the panoramic image 600 in advance and instructs the display apparatus 140 to display the graphic patterns, and transform and move the graphic patterns based on dragging operations performed on them by the user. In this case, the control unit 122 identifies a coordinate set existing inside the transformed and moved graphic patterns.

According to the present exemplary embodiment, the user is assumed to be able to specify a plurality of coordinate sets on the panoramic image 600 by repeatedly specifying a coordinate set on the panoramic image 600 by using the above-described method. However, in this case, each coordinate set is assumed to be a set of mutually different coordinates.

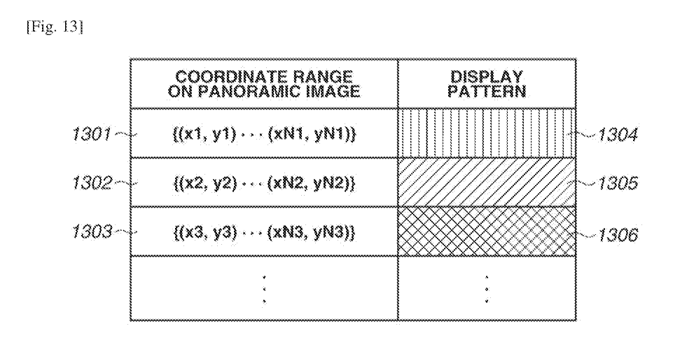

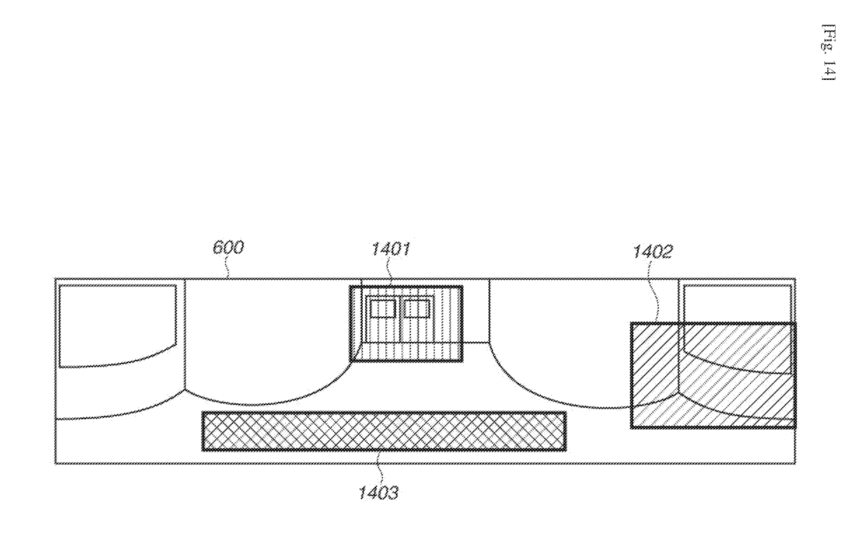

In step S1201, the display control unit 125 displays a display pattern on coordinates on the panoramic image 600 received in step S1200. FIG. 13 illustrates examples of relations between coordinate ranges on the panoramic image 600 received in step S1200 and display patterns to be displayed in the ranges in tabular form.

The present exemplary embodiment will be described below centering on an example of a case where a display pattern to be displayed in the panoramic image 600 includes points and lines. However, the display pattern is not limited thereto. A display pattern may be a graphic pattern, a color, a character string, or a combination of any two of them.

According to the present exemplary embodiment, the control unit 122 automatically associates display patterns 1304 to 1306 with coordinate ranges 1301 to 1303 on the panoramic image 600, respectively. However, the method for associating the display patterns 1304 to 1306 with the coordinate ranges 1301 to 1303 on the panoramic image 600, respectively, is not limited thereto. For example, the control unit 122 may calculate the imaging directions (pan and tilt values) of the imaging apparatus 110 based on the barycentric coordinates in coordinate ranges on the panoramic image 600 by using a conversion method (described below). In this case, the control unit 122 is able to determine the inclination of stripes of display patterns based on the calculated pan values, and determine the distance between the stripes of display patterns based on the tilt values. Based on an input operation of the user via the input apparatus 130, the control unit 122 is able to determine the display pattern, and determine the association between the display pattern and coordinate ranges on the panoramic image.

FIG. 14 illustrates an example of the displayed panoramic image 600 in which the display patterns are superimposed on coordinate ranges 1401 to 1403 on the panoramic image 600. The coordinate ranges 1401 to 1403 on the panoramic image 600 are the ranges specified by the user in step S1200. The display patterns 1304 to 1306 are assumed to be associated with the coordinate ranges 1401 to 1403, respectively. As illustrated in FIG. 14, display patterns are associated with the coordinate ranges 1401 to 1403 on the panoramic image 600 so that at least a part of areas of the original panoramic image becomes visually recognizable.

In steps S1202 to S1207, the control unit 122 performs processing for displaying display patterns on the timeline. An example of a timeline and an example of a user interface for displaying a recorded video image at a time (reproduction position) specified on the timeline are as illustrated in FIG. 10.

A description is given of an example of a flow of processing for displaying display patterns (display patterns indicating the recording time periods of images in user-specified ranges) on the timeline 1002.

<Processing 1>

In step S1202, the control unit 122 specifies the starting frame of a recorded video image. The present exemplary embodiment will be described below centering on an example of a case where the client apparatus 120 receives a recorded video image stored in the information storage unit 114 and performs processing on the recorded video image. However, it is not always necessary to perform processing in this way. For example, before performing the processing in step S1202 (processing 1), the client apparatus 120 may acquire image data captured by the imaging apparatus 110 and store a recorded video image inside the client apparatus 120.

<Processing 2>

In step S1203, the control unit 122 acquires the pan and tilt values of the imaging apparatus 110 used when the frame currently specified for the recorded video image has been captured. According to the present exemplary embodiment, the control unit 122 is assumed to acquire the pan and tilt angle values prestored, in the imaging apparatus 110, as metadata in the header of each frame of the recorded video image. However, the method for acquiring the pan and tilt values of the imaging apparatus 110 is not limited thereto. An example of this method will be described below. In recording a captured image, the control unit 122 generates a table for storing each frame of a recorded video image and the pan and tilt values of the imaging apparatus 110 in association with each other. This table may be generated by the imaging apparatus 110 or by the client apparatus 120. In step S1203, the control unit 122 derives the pan and tilt values of the imaging apparatus 110 (the imaging directions of the imaging apparatus 110) by referring to the above-described table.

<Processing 3>

In step S1204, the control unit 122 converts the pan and tilt values acquired in step S1203 (processing 2) into coordinates on the panoramic image 600. The present exemplary embodiment uses a panoramic image in which the horizontal axis corresponds to panning and the vertical axis corresponds to tilting, as illustrated in FIG. 6. Accordingly, applying the following formulas (2) and (3) to the pan and tilt values of the imaging apparatus 110 enables the control unit 122 to calculate the coordinates (x, y) on the panoramic image 600 corresponding to the pan and tilt values of the imaging apparatus 110.

$$[ Math . 2 ]$$

$$\begin{matrix}x = \frac{Pan - P min}{P max - P min} W \\ [ Math . 3 ] & ( 2 ) \\ y = ( 1 - \frac{Tilt - T min}{T max - T min} ) H & ( 3 )\end{matrix}$$

Referring to formulas (2) and (3), W and H respectively denote the width and height of the panoramic image 600, Pmax and Pmin respectively denote the maximum and minimum values of the driving range of the imaging apparatus 110 in the pan direction, Tmax and Tmin respectively denote the maximum and minimum values of the driving range of the imaging apparatus 110 in the tilt direction, and Pan and Tilt respectively denote the pan and tilt values. The present exemplary embodiment will be described below centering on an example of a case where the coordinates (x, y) on the panoramic image 600 corresponding to the pan and tilt values of the imaging apparatus 110 are calculated based on the width, height, and coordinates of the panoramic image 600. However, the method for deriving the coordinates (x, y) on the panoramic image 600 corresponding to the pan and tilt values of the imaging apparatus 110 is not limited thereto. An example of this method will be described below. First of all, when a panoramic image is generated, the control unit 122 generates a table for storing the coordinates of the panoramic image and the pan and tilt values of the imaging apparatus 110 in association with each other. This table may be generated by the imaging apparatus 110 or by the client apparatus 120. In step S1204, the control unit 122 derives the coordinates (x, y) on the panoramic image 600 corresponding to the pan and tilt values of the imaging apparatus 110 by referring to the above-described table.

<Processing 4>

Based on the relations between coordinate ranges on the panoramic image 600 and display patterns to be displayed on the panoramic image 600 (see FIG. 13), the control unit 122 refers to the display pattern corresponding to the coordinates (x, y) on the panoramic image 600 converted in the processing 3 (step S1204). In step S1205, the control unit 122 assigns the display pattern referred to by the control unit 122 to the area on the timeline 1002 indicating the currently specified frame. When there is no display pattern corresponding to coordinates (x, y) on the panoramic image converted in the processing 3 (step S1204), the control unit 122 assigns no display pattern to the coordinates (x, y).

<Processing 5>

In step S1206, the control unit 122 determines whether the frame currently specified for the recorded video image is the last frame. In a case where the frame currently specified for the recorded video image is the last frame as a result of the determination (YES in step S1206), the processing exits the flowchart illustrated in FIG. 12.

On the other hand, in a case where the frame currently specified for the recorded video image is not the last frame (NO in step S1206), then in step S1207, the control unit 122 specifies the next frame. Then, the control unit 122 performs the above-described processing in steps S1203 to S1205 on the specified frame. As described above, the control unit 122 repeatedly performs the processing in steps S1203 to S1205 until display patterns are assigned to areas on the timeline corresponding to all frames configuring the recorded video image.

In the present exemplary embodiment, after completion of the above-described processing illustrated in FIG. 12, the display control unit 125 displays the timeline having undergone the processing (timeline on which display pattern are superimposed) on the display apparatus 140.

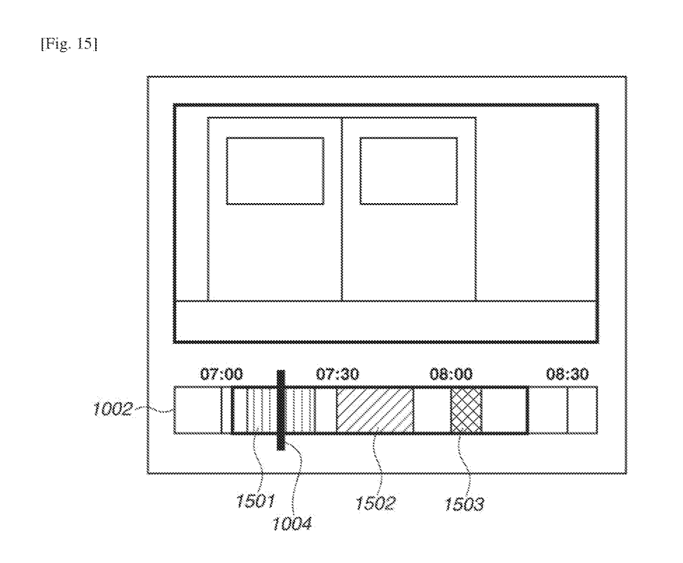

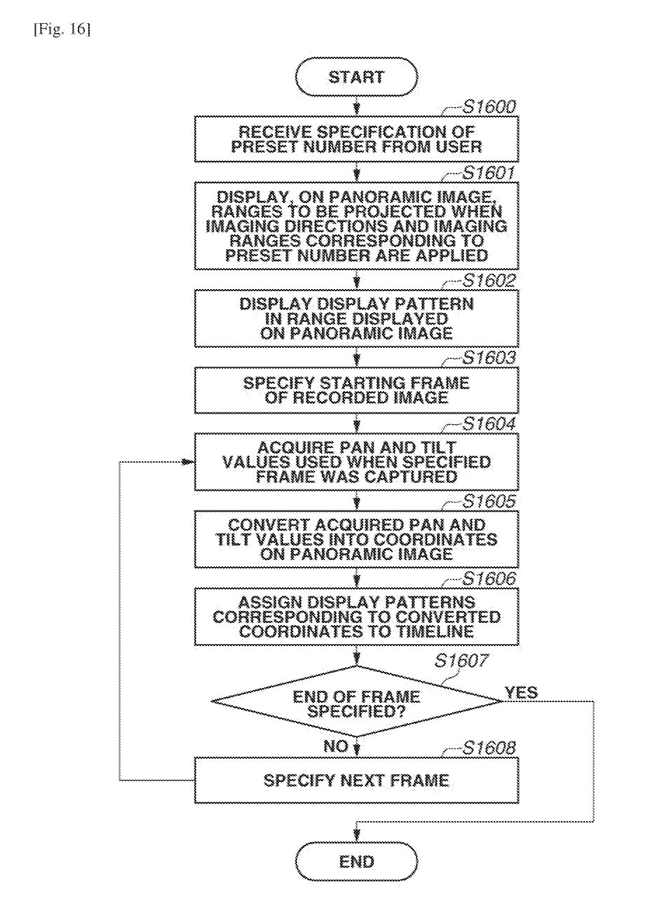

As described above, in the present exemplary embodiment, the control unit 122 stores in the storage unit 121 the areas specified on the panoramic image by the user and display patterns in association with each other. The control unit 122 identifies an area specified on the panoramic image by the user. Then, the display control unit 125 displays display patterns 1501 to 1503 corresponding to the specified imaging area on the timeline in a superimposed way so that at least a part of the contents of the original timeline and the recording time specification portion 1004 becomes visually recognizable. FIG. 15 illustrates an example of the timeline 1002 which displays the storage time periods of the images in the coordinate ranges 1401 to 1403 on the panoramic image specified by the user.

The display patterns 1501 to 1503 illustrated in FIG. 15 indicate the display patterns corresponding to the coordinate ranges 1401 to 1403 on the panoramic image, respectively. Presenting such a screen for displaying the timeline 1002 to the user allows the user to determine that, for example, the image which has recorded the coordinates range 1401 on the panoramic image exists in the period indicated by the display pattern 1501 displayed on the timeline 1002. This allows the user to intuitively identify an image in which a desired area is projected.

The present exemplary embodiment has specifically been described above centering on an example of a case where a timeline of images (recorded video images) of a plurality of continuous frames is displayed as an example of an object for selecting an image. However, it is not always necessary to display images of a plurality of continuous frames or display a timeline. For example, it is also possible to display a thumbnail image for each of a plurality of images as an example of an object for selecting any one of a plurality of the images. A plurality of images may be images of frames of a moving image or may be still images. In this case, for example, in a case where the area specified by the user is projected in an image corresponding to a thumbnail image, the display pattern according to the area can be displayed on the thumbnail image in a superimposed way. Then, the display control unit 125 displays in an enlarged way an image selected from a plurality of the thumbnail images by the user. In this case, the user may be allowed to select only one of a plurality of the thumbnail images or select at least two thereof at the same time.

The present exemplary embodiment has specifically been described above centering on an example of a case where display patterns are superimposed on a timeline. However, it is not always necessary to superimpose display patterns on a timeline. For example, in displaying the coordinate ranges 1401 to 1403 on the panoramic image 600 and the character strings indicating the recording time periods of the ranges as display patterns, the character strings may be displayed out of the timeline (for example, below the timeline).

### Fourth Exemplary Embodiment

A fourth exemplary embodiment will be described below. As described above, the present exemplary embodiment will be described below centering on a case where an imaging apparatus capable of storing the imaging directions and imaging ranges as preset information is used. The present exemplary embodiment will be described below centering on an example of a method in such an imaging apparatus. Specifically, the user specifies a preset number, and the method displays the recording time period of a video image captured in the imaging direction and imaging range corresponding to the specified preset number, on the timeline of the recorded video image of the imaging apparatus. As described above, the present exemplary embodiment differs from the third exemplary embodiment in the method for specifying a coordinate range on the panoramic image. Accordingly, in the descriptions of the present exemplary embodiment, elements identical to those in the first exemplary embodiment are assigned the same reference numerals as those in FIGS. 1 to 10, and detailed descriptions thereof will be omitted. For example, the configurations of the imaging display system, the imaging apparatus 110, and the client apparatus 120 according to the present exemplary embodiment (FIGS. 1 to 3) are similar to those according to the first exemplary embodiment, and detailed descriptions thereof will be omitted. According to the present exemplary embodiment, the space and place where the imaging apparatus 110 is installed and the driving ranges in the pan and tilt directions are similar to those according to the first exemplary embodiment.

An example of processing of the client apparatus 120 will be described below with reference to the flowchart illustrated in FIG. 16. The following describes an example of a method in which the client apparatus 120 calculates the imaging direction of the imaging apparatus 110 based on the preset number specified by the user and displays the recording time period of a video image in the calculated imaging direction on the timeline of the recorded video image. The processing of the flowchart illustrated in FIG. 16 is implemented, for example, when the CPU 301 executes, via the RAM 302, a program stored in the ROM 303 or HDD 305.

In step S1600, the input acquisition unit 124 receives a preset number specified by the user. Under control of the control unit 122, a communication control unit 123 requests the imaging apparatus 110 for the preset information corresponding to the received preset number. The information storage unit 114 stores the preset information including the imaging directions and imaging ranges of the imaging apparatus 110 as an example of setting information. Upon reception of an instruction from the client apparatus 120, the communication control unit 115 extracts information about each frame of the recorded video image (panoramic image) and the preset information stored in the information storage unit 114 and transmits these pieces of information to the client apparatus 120. The present exemplary embodiment will be described below centering on an example of a case where the client apparatus 120 receives the preset information corresponding to the preset number specified by the user from the imaging apparatus 110. However, the method for acquiring the preset information is not limited thereto. The preset information may be stored in the client apparatus 120.

In step S1601, the display control unit 125 displays on the panoramic image the range to be projected when the preset information (imaging directions and imaging ranges) corresponding to the preset number received in step S1600 is applied to the imaging apparatus 110. According to the present exemplary embodiment, the control unit 122 converts the imaging direction (pan and tilt values) stored in the preset information into coordinates (x, y) on the panoramic image by using formulas (1) and (2). Then, the control unit 122 extracts information about the imaging range stored in the preset information and determines the width and height of the range on the panoramic image by using the following formulas (4) and (5), respectively. In the present exemplary embodiment, the position and size of the area corresponding to the preset number are identified as described above.

$$[ Math . 4 ]$$

$$\begin{matrix}width = \frac{zoom}{P max - P min} W \\ [ Math . 5 ] & ( 4 ) \\ height = \frac{zoom}{P max - P min} W \cdot R & ( 5 )\end{matrix}$$

Referring to formulas (4) and (5), W denotes the width of the panoramic image 600, Pmax and Pmin respectively denote the maximum and minimum values of the driving range of the imaging apparatus 110 in the pan direction, R denotes the aspect ratio of a captured image, and zoom denotes the zoom magnification in the imaging apparatus 110.

The display control unit 125 draws a rectangle having a width and a height centering on the coordinates (x, y) on the panoramic image 600 and instructs the display apparatus 140 to display the rectangle.

Then, the control unit 122 assigns a display pattern to the coordinates set in the rectangle displayed in step S1601. In step S1602, the display control unit 125 draws a display pattern assigned by the control unit 122 in respective ranges on the panoramic image 600 and instructs the display apparatus 140 to display the display pattern. As in the first exemplary embodiment, the control unit 122 manages coordinates existing in the rectangle as a coordinate set and, as illustrated in FIG. 7, generate relations between coordinate ranges on the panoramic image 600 and display patterns to be displayed in respective ranges on the panoramic image 600, also in the present exemplary embodiment. By performing processing in this way, ranges on the panoramic image 600 can be associated with display patterns to be displayed in respective ranges on the panoramic image 600.

In step S1603 to S1608, the control unit 122 performs processing for displaying display patterns on the timeline. According to the present exemplary embodiment, similar to the first exemplary embodiment, the control unit 122 determines whether the imaging direction stored in frames of a recorded video image is included in the ranges displayed on the panoramic image 600. More specifically, the processing in steps S1603 to S1608 can be implemented by the processing in steps S1202 to S1207, respectively. Accordingly, detailed descriptions of these pieces of processing will be omitted.

Performing the above-described processing also provides the advantageous effects described in the third exemplary embodiment. In the present exemplary embodiment, the modification according to the third exemplary embodiment can also be employed.

The above-described exemplary embodiments should be considered to be illustrative in embodying the present invention, and not restrictive of the scope of the present invention. The present invention may be embodied in diverse forms without departing from the technical concepts or essential characteristics thereof.

### Other Exemplary Embodiments

The present invention is implemented also by performing the following processing. More specifically, software (computer program) for implementing the functions of the above-described exemplary embodiments is supplied to a system or apparatus via a network or various types of storage media, and a computer (or CPU or micro processing unit (MPU)) of the system or apparatus reads and executes the computer program.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)(trade mark), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-236065, filed Dec. 2, 2015, and No. 2015-236066, filed Dec. 2, 2015, which are hereby incorporated by reference herein in their entirety.

1. An image reproducing apparatus comprising:
a display processing unit configured to process display of a timeline indicating a time period during which an image captured by a camera capable of changing an imaging direction is recorded, the display of the time period on the timeline being processed depending on the imaging direction; and
an image reproducing unit configured to reproduce an image corresponding to a time specified on the timeline.

2. The image reproducing apparatus according to claim 1,
wherein the display processing unit performs processing for further displaying a panoramic image generated by combining a plurality of images captured while the imaging direction is being changed, and
wherein, according to the imaging direction, the display processing unit performs processing for displaying areas on the panoramic image and the time period during which the image is recorded on the timeline in association with each other.

3. The image reproducing apparatus according to claim 1, wherein the display processing unit performs processing for displaying display patterns according to the imaging direction of the camera on the time period.

4. The image reproducing apparatus according to claim 2, wherein, according to a specification of the imaging direction on the panoramic image, the display processing unit performs processing for displaying a time period corresponding to the specified imaging direction so as to be distinguishable from a time period corresponding to another imaging direction not specified.

5. An image reproducing method comprising:
processing for displaying of a timeline indicating a time period during which an image captured by a camera capable of changing an imaging direction is recorded, the display of the time period on the timeline being processed depending on the imaging direction; and
reproducing an image corresponding to a time specified on the timeline.

6. The image reproducing method according to claim 5, wherein, in the processing for display, display of a panoramic image generated by combining a plurality of images captured while the imaging direction is being changed is processed, and processing for displaying areas on the panoramic image and the time period during which the image is recorded on the timeline in association with each other is performed, according to the imaging direction.

7. The image reproducing method according to claim 5, wherein, in the processing for display, processing for displaying display patterns according to the imaging direction of the camera on the time period is performed.

8. The image reproducing method according to claim 6, wherein, according to a specification of the imaging direction on the panoramic image, in the processing for display, processing for displaying a time period corresponding to the specified imaging direction so as to be distinguishable from a time period corresponding to another imaging direction not specified is performed.

9. A non-transitory computer readable medium storing a program for causing a computer to execute an image reproducing method comprising:
processing for display of a timeline indicating a time period during which an image captured by a camera capable of changing an imaging direction is recorded, the display of the time period on the timeline being processed depending on the imaging direction; and
reproducing an image corresponding to a time specified on the timeline.

10. The non-transitory computer readable medium according to claim 9, wherein, in the processing for display, display of a panoramic image generated by combining a plurality of images captured while the imaging direction is being changed is processed, and processing for displaying areas on the panoramic image and the time period during which the image is recorded on the timeline in association with each other is performed, according to the imaging direction.

11. The image reproducing method according to claim 9, wherein, in the processing for display, processing for displaying display patterns according to the imaging direction of the camera on the time period is performed.

12. The image reproducing method according to claim 10, wherein, according to a specification of the imaging direction on the panoramic image, in the processing for display, processing for displaying a time period corresponding to the specified imaging direction so as to be distinguishable from a time period corresponding to another imaging direction not specified is performed.
